(19) United States
(12) Patent Application Publication
(10) Pub. No.: US 2012/0130555 A1
(43) Pub. Date: May 24, 2012

(54) HYBRID ENERGY CUBE

(76) Inventor: Howard JELINEK, Laguna Beach, CA (US)

(21) Appl. No.: 12/952,521

(22) Filed: Nov. 23, 2010

(51) Int. Cl. G06F 1/26

(52) U.S. Cl. 700/291

(57) ABSTRACT

A resource management system includes an electrical module having inputs and outputs, a water module having inputs and outputs, a gas module having inputs and outputs, a control module for monitoring on-site demand and managing operation of the electrical, water, and gas modules for converting and redistributing at least one of electric, chemical, mechanical, and heat energy to effect low operational costs, and a control bus interconnecting the electrical, water, gas, and control modules.

In the industrialized world, consumers, businesses, and industry currently purchase their energy—electricity, water, and gas—through utilities. Utility companies acquire, generate, store, distribute and deliver bulk energy to homes and businesses using road or rail transport and through wires and pipes, to local storage and re-distribution facilities and finally to the curb. Overhead costs for distributing energy range from 5 to 30% of the final price charged to the end consumer “at the curb”. While consumer conservation measures can be applied to reduce actual energy used, consumer costs for utility supplied energy will continue to rise. Consumers can control costs by seeking alternative supplies or by on site energy recovery and generation. To reduce consumer energy costs permanently long term, a method and system for on site management and replacement of curbside energy is disclosed.

### SUMMARY OF INVENTION

A resource management system and method, also referred to herein as a Hybrid Energy Cube (HEC), in accordance with the present invention generally includes an electrical module having inputs and outputs, a water module having inputs and outputs, a gas module having inputs and outputs a control module for monitoring on-site demand and managing operation of the electrical, water, and gas modules for converting and redistributing at least one of the electric, chemical, mechanical, and heat energy to effect low operational costs; and a control bus interconnecting the electrical, water, gas, and control modules.

More particularly, the HEC described herein is a new energy monitoring, storage, management, and redistribution system focused primarily on manufactured homes, residential and small facility energy saving applications.

The HEC manages the storage and regeneration of “Green” electrical energy generated (scavenged) from photovoltaic, wind, and other sources. It allows end users to switch between utility supplied energy or, alternatively, site-supplied energy. Stored electrical energy supplements or replaces utility provided electrical energy. The HEC is installed at the site of consumption between the incumbent energy provider(s) and the end customer. Stored electrical energy supplements or replaces utility provided electrical energy.

The HEC is installed at the site of consumption between the incumbent energy provider(s) and the end customer.

The HEC manages water supplied from the utility or alternatively, acquired though on-site water collection of rainwater or recycled water. Solar water heating and separate irrigation and cold water systems are provided. Biogas or bottled gas located on premises or acquired from an external source can supplement or replace utility provided low-pressure natural gas.

The HEC supports 24/7 real time on-site energy conversion management. In addition to managing electrical energy storage and conversion and water redistribution, the HEC provides on-site gas compression to generate CNG for refueling converted or hybrid cars and H₂O or CH₄ to H₂ conversion for use in on-site fuel cells.

The control module controls operation of the HEC electrical, gas, and water modules through the data communication bus. The control module executes management software, which provides communication, data acquisition, and control functions. The control module also interoperates with the Smart Grid and the Internet.

The control module supports a wireless interface, which permits the HEC to communicate with legacy and future in-home environmental management and entertainment systems. The HEC may be configured for stand alone operation in a NEMA-type cabinet, integrated into heat pump or air conditioning/heating units, or configured and deployed as a distributed system with individual modules located close to the sources or points of use of the energy.

### BRIEF DESCRIPTION OF THE DRAWINGS

The function, advantages, and features of the present invention will be better understood by the following description when considered in conjunction with the accompanying drawings in which:

FIG. 1 is an illustration of implementation of a resource management system, or Hybrid Energy Cube (HEC) in accordance with the present invention;

FIG. 2 is a block diagram of HEC system diagram depicting the modules, the bus connections, and one embodiment or configuration for energy inputs and outputs;

FIG. 3 is a HEC block diagram depicting on site fuel cell support;

FIG. 4 illustrates a possible HEC module ‘stacked’ configuration;

FIG. 5 illustrates HEC residential support, a 1 megaWattHr per month version'

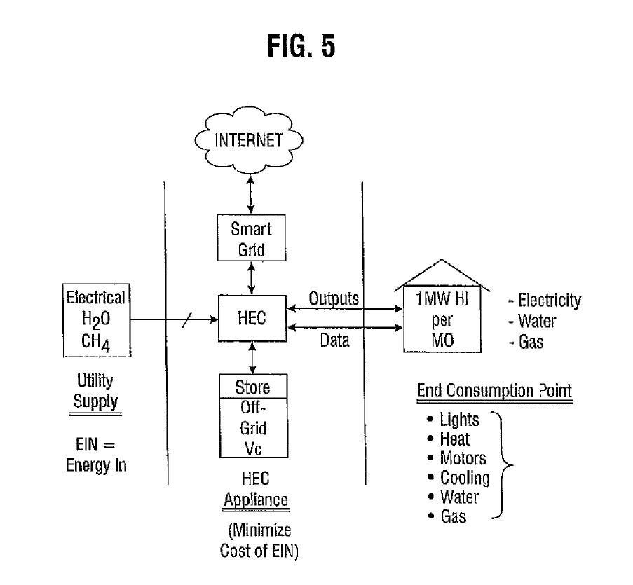

FIG. 6 is a diagram that shows a breakdown of the electrical module components and Gas, Water, and Solar management components and their functional relationship; and

FIG. 7 is a detailed functional diagram.

### DETAILED DESCRIPTION

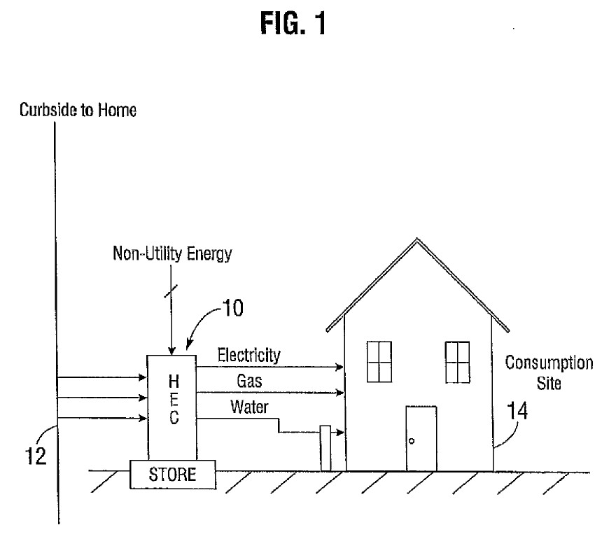

As illustrated in FIG. 1, the HEC 10 intercepts curbside 12 energy and supplements and manages on-site 14 energy redistribution. Interfacing with the Smart Grid, Internet, and possibly home management systems (not shown), the HEC 10 supports a home energy supply that is green, lowest cost, reliable, and renewable. By having on site management, generation and storage, consumers will be able to reduce their costs and mitigate total reliance on utility supplied source(s).

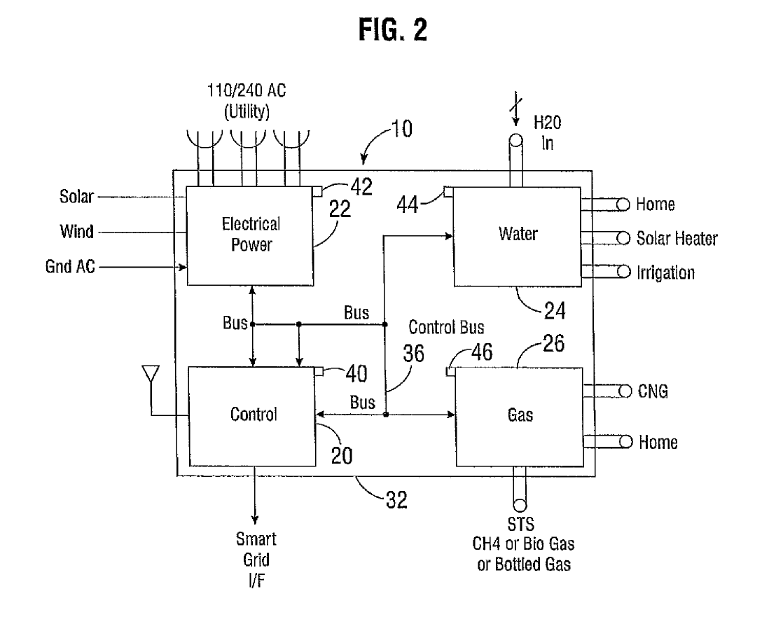

With reference to FIG. 2, the HEC 10 may include four functionally unique modules, namely a control module 20, an electrical module 22, a water module 24, and a gas module 26. The modules 20, 22, 24, 26 are configured to slide fit into a single “master” enclosure 32 or geographically distributed around the installation. Modules 20, 22, 24, 26 may be easily removed and replaced. The modules 20, 22, 24, 26 communicate through a communication bus 36 with the control module 20. Modules 20, 22, 24, 26 may equally well be spatially distributed and located in convenient locations, close to the sources or point of use of the power, water, or gas. The electrical module 22 is isolated so that ground faults, lightening, or electrical shorts will not damage or endanger humans or animals. Similarly, the gas module 26 is constructed to prevent leaks and potential explosion. By integrating all sensors, switches, and valves into each single closed unit module, maintenance is simplified and operating safety is ensured.

The control module 20 connects to all other system modules 20, 22, 24, 26 through the control bus 36 that is electrically isolated using optical, wireless, or other electrical isolating technology. A wired example of this type of bus is power over Ethernet or USB (not shown). Because the electrical module 22 contains high voltages up to 1000 volts, safety requirements require isolation of other system components from HVDC and HVAC. The control bus 36 provides for communicating all signaling, sensor, data, and control. The modules 20, 22, 24, 26 may each contain an isolated low voltage supply. The control module 20 also supports a Smart Grid interface (not shown) enabling future interoperation with utilities. The HEC 10 supports utility load shedding, the ability to schedule power purchasing, and grid-tie operation. The control module 20 incorporates wireless and Ethernet links to communicate with short range interconnect devices.

Each of the modules, 20, 22, 24, 26 alternatively referred to here as a manifold, contains a primary input, secondary (auxiliary) input(s), and outputs. The control module 20, through the control bus 36 monitors module energy inputs and outputs and sends control information back to the modules 22, 24, 26. Primary inputs are utility supplied electricity, utility supplied gas, and utility supplied water. Secondary inputs from scavenged or site provided sources such as on-site solar, wind, bio gas, well water, reclaimed water sources etc. may also come from secondary utility companies or suppliers.

Each module contains sensors 40, 42, 44, 46 that monitor the quantity and quality of each module's energy inputs and outputs. The electrical module 22 monitors voltages, currents, and power in all electrical circuits. The water module 24 contains flow and pressure sensors, and switches and valves to select sources and to gate them to the module outputs. The gas module 26 contains low and pressure sensors and selectors and valves to route and reroute gas to the outputs. Sensor data passes from modules to the controller via the bus and control data flows from the controller to the modules and peripherals.

A common function of each module 20, 22, 24, 26 is to select and switch energy sources (inputs) to respective outputs. For example, the electrical module 24 contains electrical switches to select primary or secondary sources and “gate” them to the output circuits. The selectors and switches are enabled through the control bus signals and operate in response to the control module software.

Operating as an autonomous control system, the HEC 10 will actively select and reroute energy resources on a real time basis. The control module 20 monitors the on-site demand and provides source selection to control and route energy that results in the lowest operational cost. Software will select between autonomous operation and Smart Grid or home energy management aware operation (not shown).

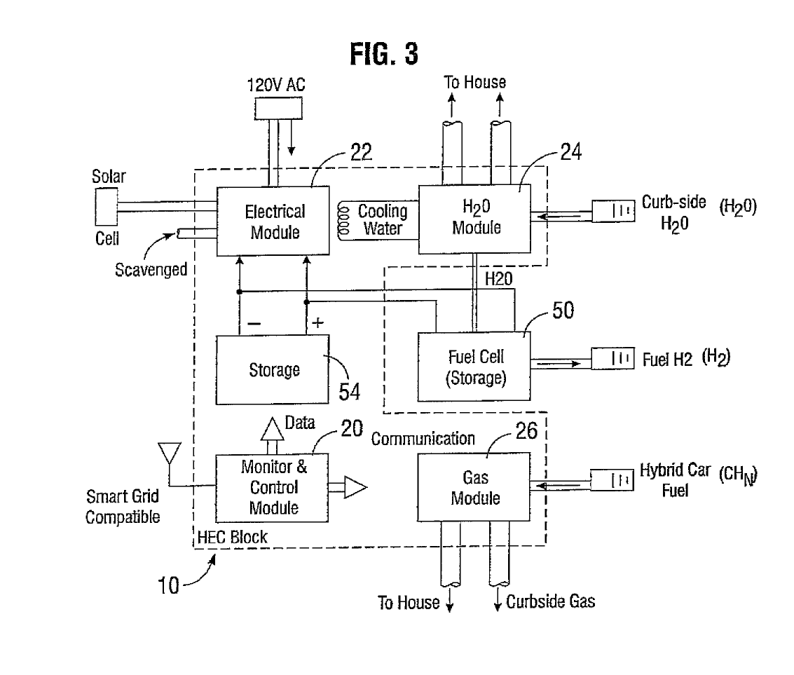

FIG. 3 shows the HEC 10 configured to operate in an off grid mode using a fuel cell or other electrical generator to generate supplementary electrical energy. The control module 20 (monitor and control module) manages the operation of the electrical module 22, the gas manifold 26, and the water manifold 24. One detail outlined is the potential use of Cooling Water (24) to cool the electrical module and store which may be required in desert or high ambient temperature applications of the HEC. While most homes in developed countries have access to utility provided water, electricity, and gas, in some undeveloped countries, secondary sources of water and gas may be supplied if there is no access to primary utility sources. The HEC 10 will support the selection of an optimal “operating mode” based on consumption patterns, cost of energy, system capacity, supply availability, inputs from home-management systems, the Smart Grid interface and other factors. NEMA type enclosures may be used for stand alone packaging or when incorporating the HEC 10 with air conditioning, heating, or heat pump units. The STORAGE 54 may be sized to support the desired sustainable electrical output. Off grid auxiliary (electrical) generators may be co-located with other types of electrical generators such as fuel cells 50 (FIG. 3), combustion engine generators, motor generator units, and other types of energy scavenging appliances (not shown).

For grid tie operation, the electrical module 22 can select between grid power or locally generated AC power to supply local circuits or simultaneously supply grid to one circuit and locally generated AC to a second circuit. Depending on the capacity of the store and output from on-site solar or wind generators, locally generated “green” AC may supply substantially all on site requirements, which will minimize energy procurement cost and pollution. Similarly, the HEC 10 monitors and selects the source and amount of gas and water to be supplied to the “outlet circuit”. The HEC 10 monitors use and can interoperate with in-home energy management systems to provide the most cost effective and “carbon sensitive” modes of operation. Fuel cell 50 support, as a supplemental source of electrical energy, is further illustrated. Where fuel cell technology is for off-grid ‘back up’ or for supplementing scavenged energy, advantage can be taken of the heat generated by the fuel cell to preheat water or the heat may be used as a source for home heating. Note the H2 (hydrogen) input may be generated by separating the H2 from CH4 or by separating hydrogen from of H2O.

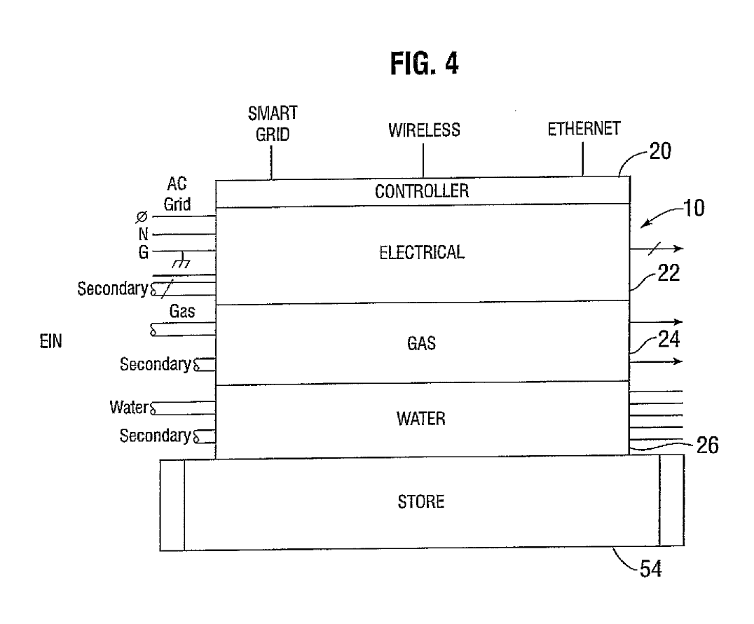

FIG. 4 illustrates a typical ‘stacked’ configuration. Gas, electricity, and water inputs are shown as energy in, EN made up of primary and secondary sources of the respective energy sources. Outputs from the energy modules, (10,22), 23,26 are not called out explicitly but may be configured in appropriate combination to support customized control and supply. The HEC 10 is packaged as a number of modules 20, 22, 24, 26, which may be distributed or located in a single enclosure.

Smart grid support is implemented through the control module 20 and supported through an Internet port or smart grid specific interface shown in FIG. 3. Data from a home management system home (not shown) may be used to determine HEC operating mode, monitor and control lights, thermostats, and security systems, etc. (not shown).

All electrical energy may be stored in a storage module 54 before it is converted to AC. Energy from photovoltaic panels, or from generators/alternators, or from grid supplied electrical energy may be stored for later conversion. Although the HEC supports storage of utility provided AC, it is generally used directly to maximize efficiency and eliminate conversion losses. The storage module 54 is made up from batteries, capacitors, or equivalent devices. The store provides the DC voltage for the DC to AC inverter. Energy may be stored in other forms and converted to DC. Off-grid operation is generally supported through the inclusion of a generator, small fuel cell, or other compatible auxiliary generation device.

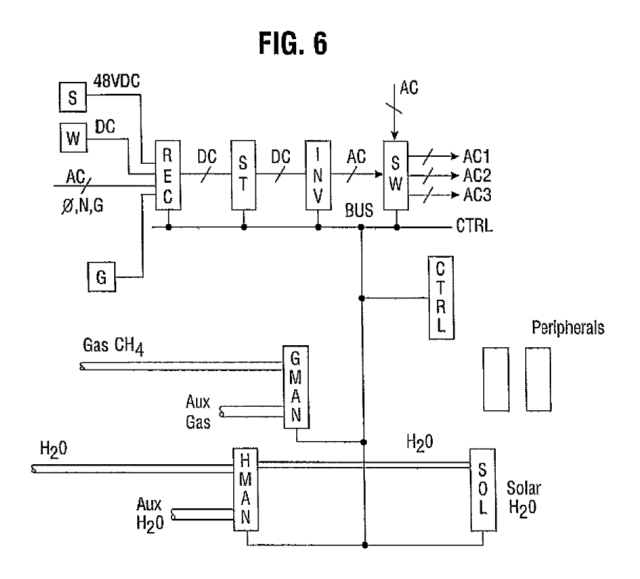

As shown in FIG. 6, each module (manifold) has primary and secondary inputs, and interfaces with the control bus, and to several outputs. The number, type, and connection of outputs is determined by the particular requirements of the installation. For example, the electrical outputs may supply circuits for the home, for the air conditioner(s), and for refrigeration systems. Gas outputs for cooking and heating, or high pressure (CNG) for fueling converted or hybrid engines are provided. Water outputs support solar water heating units, home cold water, and home irrigations systems.

FIG. 6 shows the major module components and their functional relationships. The electrical section contains the following components:
REC=rectifier unit
ST=store (the store is an independent module; it's capacity is sized for the location)
INV=inverter unit. This is the DC to AC converter.
SW=switch unit. The switch unit allows the HEC to dynamically select grid AC or HEC generated AC.

The control module, CTRL, contains a computation unit, control, bus interface, and communication interface.

The CTRL module supports the Smart Grid interface and monitors the state of the HEC to determine the control to use to support the most cost effective distribution of energy (electrical, gas, and water) on a 24/7 schedule. The control program adjusts to the time of day, time of year, and the status of the store. The CTRL module will provide autonomous automatic operation for off grid units or when Smart Grid control is not active.

FIG. 6 also shows the following to modules:
GMAN=gas manifold
WMAN=water manifold

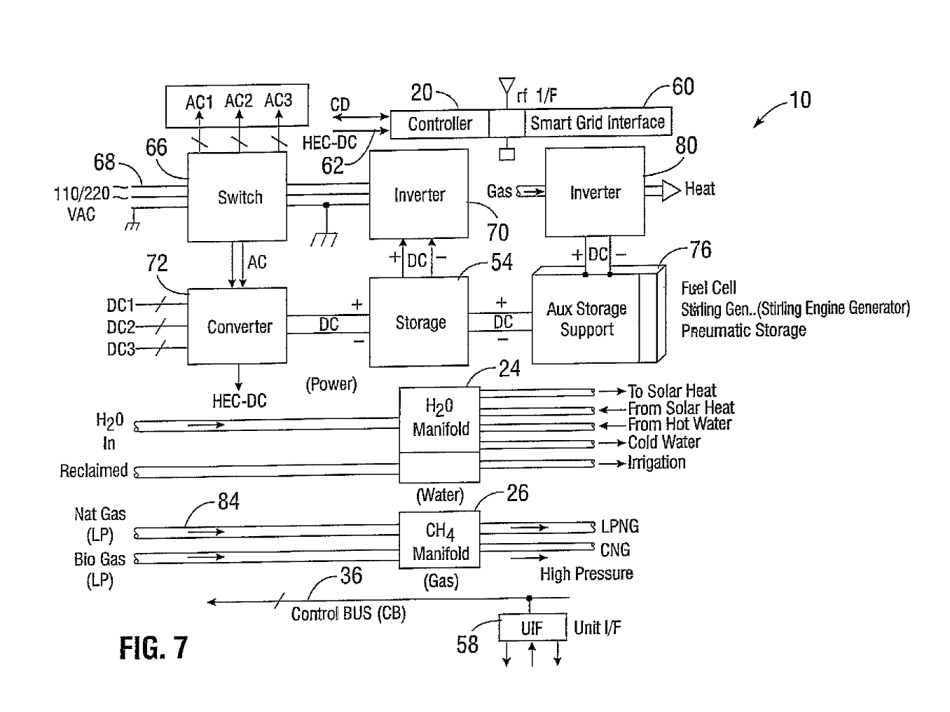

With reference to FIG. 7, the hybrid energy cube 10 is designed to inter-operate with home management systems through a wireless interface and through a Smart Grid interface 60. Wide area HEC deployment will beneficially serve to stabilize the grid in times of high electrical power demand by load shedding. Rapid HEC deployment could advantageously delay the anticipated build out of the existing HV distribution systems in the USA. The HEC 10 also offers a solution for residential customers to manage the utilization of purchased energy, while conserving power, water, and gas use. Single-family residences typically provide sufficient roof top area for up to 8 KW (40 Panels @ 200 W each) of photovoltaic panels and 50 gallon water solar heating units. Wind energy scavenging may be done on-site or from an area shared by several residences.

The hybrid energy cube 10 provides gas and water energy management as well as on-site AC power generation. The primary application is for a typical single-family residence or (manufactured home) located in an area where solar or wind energy, or both, can be economically scavenged. HEC units may be designed to support off-grid as well as on grid applications. The HEC 10 manages and minimizes the use of electrical energy and water usage. It also manages distribution and local compression of low-pressure natural gas or biogas.

For on grid applications, the Smart Grid interface 60 provides access through the control module to real time sensor measurements of on site power, water, and gas use. The HEC 10 contains sensors which continuously monitor electrical power, and the pressure and flow of gas and water. This sensor information is transmitted on the control bus 36 through a User Interface (UIF) 58. The UIF is provided in all HEC modules and peripherals and supports the physical interface for the control bus. Control signals are transmitted through the bus 36 from the control module to the electrical module 22. Control signals are also sent through the bus 36 to the water and gas modules as control information to operate valves and switches in the water and gas manifolds 24, 26.

The HEC control module 22 operating power is from the HEC-DC supply 62. The control module 20 is the master port for the control bus (CB) 36 and contains the wireless (rf TN) and Ethernet interface. It control module 20 supports the Smart Grid Interface. The CB 36 communicates with each unit module, ULF 58.

The CB 36 carries sensor data and control data to and from each of the modules 20, 22, 24, 26. The CB 36 may be wired or wireless electrically isolated from the modules.

The switch 66 receives 120/220V AC power from the utility drop 68. It also has 120/220 VAC available from an inverter 70. The AC power outputs 120 or 240 VAC connect to circuits in the home or possibly directly to air conditioner, heat pump, or heating units. There is at least one AC output available through the switch 66 shown in FIG. 7.

A converter 72 has direct current inputs DC1, DC2, DC3, and alternating current input, AC. The converter 72 outputs are DC and HEC-DC. The DC output (+,−) connects to the storage unit 54. The direct current output from the storage unit 54 is DC OUT that connects to the inverter 20. A DC from an Aux storage support unit 76 also connects to the storage unit 54. The Aux storage 76 unit may be one of a number of devices such as a motor generator, fuel cell, electrical generator, battery set, stirling engine generator, rectified AC, that can generate DC voltage. The Aux storage support unit 76 may receive DC from a converter 80. HEC's 10 may be equipped with converter 80 or may support an external converter (not shown). Gas from the CH4 manifold 26, may be used to provide fuel for the converter 80. Converters generate a DC voltage and heat.

Control and distribution of water is provided in the H₂O manifold 24. Utility supplied water or reclaimed water may be distributed. The H₂O manifold supports solar water heating, cold water to the home, or irrigation water. Water use is monitored and flow is regulated using the H₂O manifold 24. The control module 20 regulates and controls the H₂O manifold 24 through the UIF 58.

Utility supplied NAT gas 84 is monitored, compressed, and distributed through the CH4 manifold 26. Low Pressure Natural Gas (LPNG) from the utility may be compressed and distributed as Compressed Natural Gas (CNG) for home fueling. Natural gas or Bio Gas flow can be monitored and the Smart Grid can alert the control module to switch from LP Gas to Bio Gas or vice versa. The control module 20 allows automatic shut off to occur in the event of a seismic event or at the discretion of the HEC 10 maintenance operator.

Although there has been hereinabove described a hybrid energy cube in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A resource management system comprising:
an electrical module having inputs and outputs;
a water module having inputs and outputs;
a gas module having inputs and outputs;
a control module for monitoring on-site demand and managing operation of the electrical, water, and gas modules for converting and redistributing at least one of electric, chemical, mechanical, and heat energy to effect low operational costs; and
a control bus interconnecting the electrical, water, gas, and control modules.

2. The system according to claim 1 further comprises an electrical storage module interconnected with said control bus.

3. The system according to claim 2 wherein the electrical module, water module, gas module, control module, and electrical storage module are disposed in a single housing.

4. The system according to claim 2 further comprising a fuel cell module interconnected with said control bus and operated by said control module.

5. The system according to claim 4 wherein the modules are configured for receiving on-site solar and kinetic energy.

6. The system according to claim 4 wherein the modules are configured for receiving scavenged energy in electrical form and converting the received scavenged energy to chemical, heat, or mechanical energy.

7. The system according to claim 4 wherein the modules are configured for transforming energy into an alternate form, the transformation being selected from a group consisting of methane to hydrogen, hydrogen to electrical energy, hydrogen to heat, methane to electrical energy, and methane to heat.

8. A method for providing resource management, said method comprising:
providing an electrical module having inputs and outputs;
providing a water module having inputs and outputs;
providing a gas module having inputs and outputs;
providing a control module for monitoring on-site demand and managing operation of the electrical, water, and gas modules for converting and redistributing at least one of electric, chemical, mechanical, and heat energy to effect low operational costs; and
providing a control bus interconnecting the electrical, water, gas, and control modules.

9. The method according to claim 8 further comprises providing an electrical storage module interconnected with said control bus.

10. The method according to claim 9 wherein the electrical module, water module, gas module, control module, and electrical storage module are provided in a single housing.

11. The method according to claim 9 further comprising providing a fuel cell module interconnected with said control bus and operated by said control module.

12. The method according to claim 11 further configuring the modules for receiving on-site solar and kinetic energy.

13. The method according to claim 11 further configuring the modules for receiving scavenged energy in electrical form and converting the received scavenged energy to chemical, heat, or mechanical energy.

14. The method according to claim 11 further configuring the modules for transforming energy into an alternate form, the transformation being selection from a group consisting of methane to hydrogen, hydrogen to electrical energy, hydrogen to heat, methane to electrical energy, and methane to heat.
